(19) United States
(12) Patent Application Publication
(10) Pub. No.: US 2020/0105077 A1
(43) Pub. Date: Apr. 2, 2020

(54) OPTIMAL COMMUNICATION EMITTER AND EMITTING METHOD

(71) Applicant: BOE TECHNOLOGY GROUP CO., LTD., Beijing (CN)

(72) Inventor: Wei CAO, Beijing (CN)

(21) Appl. No.: 16/422,815

(22) Filed: May 24, 2019

(30) Foreign Application Priority Data
Sep. 30, 2018 (CN) 201811155371.1

(51) Int. Cl. G07C 9/00

(52) U.S. Cl. CPC G07C 9/00182; H05B 37/0281; G07C 2009/00246

(57) ABSTRACT

The present disclosure discloses an optical communication emitter and an optical communication receiver, an emitting method and a receiving method, an optical communication transceiving system and a key for an optical communication smart door lock. The optical communication emitter includes: at least one light emitting unit, each light emitting unit comprising at least two light sources, each of the at least two light sources emitting light of a different color, wherein a unit optical communication time is divided into a number of time slots, which number correspond to the number of the light sources included in each light emitting unit, each time slot corresponds to the light sources that emit light of the same color, the light sources corresponding to different time slots are different, and each of the light sources can only emit light in the corresponding time slot.

### CROSS-REFERENCE TO RELATED APPLICATION(S)

This application claims priority to Chinese Application No. 201811155371.1, entitled “OPTICAL COMMUNICATION EMITTER AND RECEIVER, EMITTING METHOD AND RECEIVING METHOD” and filed on Sep. 30, 2018, which is incorporated herein by reference in its entirety.

### TECHNICAL FIELD

The present disclosure relates to the field of optical communication technologies, and in particular, to an optical communication emitter, an emitting method, an optical communication transceiver system, and a key for an optical communication smart door lock.

### BACKGROUND

Currently, wireless communication technologies, such as WiFi (Wireless Fidelity), Bluetooth, are already very common in people's daily life. However, further development of wireless communication technologies is restricted due to limited wireless spectrum resources. Optical communication has advantages of a wider transmission frequency bandwidth, a larger communication capacity and a longer transmission distance, and thus becomes an important part of the new generation of trusted network structures.

### SUMMARY

A first aspect of the present disclosure provides an optical communication emitter, including:

at least one light emitting unit, each light emitting unit comprising at least two light sources, each of the at least two light sources emitting light of a different color,

wherein a unit optical communication time is divided into a number of time slots, which number corresponds to the number of the light sources included in each light emitting unit, each time slot corresponds to the light sources that emit light of the same color, the light sources corresponding to different time slots are different, and each of the light sources can only emit light in the corresponding time slot.

Alternatively, the optical communication emitter is configured to adjust a brightness of light emitted by at least one of the at least two light sources in each of the at least one light emitting unit, and the brightness adjustment is invisible to naked eye(s).

Alternatively, the optical communication emitter further includes:

a clock controller configured to control the light sources to emit light in the corresponding time slots.

Alternatively, the light source is any of an Organic Light-Emitting Diode (OLED), a micro-LED or an LED.

Alternatively, the optical communication emitter further comprises a voltage controller configured to adjust a voltage applied to the at least one of the at least two light sources, so as to adjust a brightness of the light emitted by the at least one of the at least two light sources.

Alternatively, the at least one light emitting unit includes a plurality of light emitting units arranged in an array.

Alternatively, each of the plurality of time slots has the same or a different duration.

A second aspect of the present disclosure provides an emitting method of an optical communication emitter, the optical communication emitter including: at least one light emitting unit, each light emitting unit comprising at least two light sources, each of the at least two light sources emitting light of a different color, the emitting method including:

dividing a unit optical communication time into a number of time slots, which number corresponds to the number of the light sources included in each light emitting unit, each time slot corresponding to the light sources that emit light of the same color, and the light sources corresponding to different time slots being different; and

controlling each of the light sources to emit light in the corresponding time slot.

Alternatively, the emitting method further includes:

adjust a brightness of light emitted by at least one of the at least two light sources in each of the at least one light emitting unit, wherein the brightness adjustment is invisible to naked eye(s).

A third aspect of the present disclosure provides an optical communication transceiving system, including an optical communication emitter and an optical communication receiver. The optical communication emitter includes at least one light emitting unit, each light emitting unit including at least two light sources, each of the at least two light sources emitting light of a different color, wherein a unit optical communication time is divided into a number of time slots, which number corresponds to the number of the light sources included in each light emitting unit, each time slot corresponds to the light sources that emit light of the same color, the light sources corresponding to different time slots are different, and each of the light sources can only emit light in the corresponding time slot. The optical communication receiver includes at least one light receiving unit, wherein each light receiving unit comprises at least two optical filters and photodetectors, wherein the at least two optical filters are used for filtering out light of different colors emitted by the at least two light sources respectively, and the photodetector detects light emitted by a corresponding light source, which is filtered out by the corresponding optical filter, and outputs a first electrical signal.

A fourth aspect of the present disclosure provides a key for an optical communication smart door lock, wherein the key comprises the optical communication emitter according to the first aspect.

### BRIEF DESCRIPTION OF THE DRAWINGS

Particular embodiments of the present disclosure will be further described in detail below with reference to the accompanying drawings.

FIG. 1 is a block diagram showing a structure of an optical communication emitter according to an embodiment of the present disclosure;

FIG. 2 is a schematic diagram showing light emitting units arranged in an array according to an embodiment of the present disclosure;

FIG. 3 is a schematic structural diagram of a light emitting unit according to an embodiment of the present disclosure;

FIG. 4 is a schematic diagram showing composite light emitted by an optical communication emitter according to an embodiment of the present disclosure;

FIG. 5 is a block diagram showing a structure of an optical communication emitter according to another embodiment of the present disclosure;

FIG. 6 is a schematic diagram showing composite light emitted by an optical communication emitter according to another embodiment of the present disclosure;

FIG. 7 is a flow chart showing an emitting method according to an embodiment of the present disclosure;

FIG. 8 is a block diagram showing a structure of an optical communication receiver according to an embodiment of the present disclosure;

FIG. 9 is a block diagram showing a structure of an optical communication receiver according to another embodiment of the present disclosure;

FIG. 10 is a flowchart showing a receiving method according to an embodiment of the present disclosure;

FIG. 11 is a block diagram showing a structure of an optical communication transceiving system according to an embodiment of the present disclosure.

### DETAILED DESCRIPTION

In order to explain the present disclosure more clearly, the present disclosure will be further described in conjunction with the preferred embodiments and the accompanying drawings. Similar components in the drawings are denoted by the same reference numerals. It should be understood by those skilled in the art that the following detailed description are illustrative and not for the purpose of limiting, and should not limit the scope of the present disclosure.

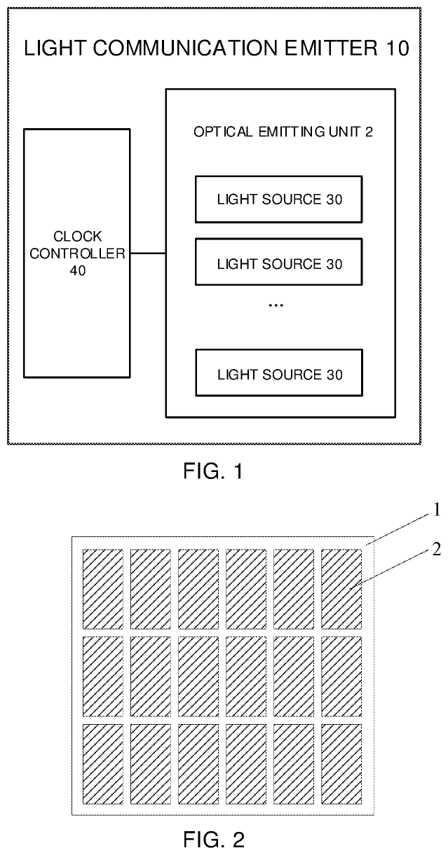

As shown in FIG. 1, an embodiment of the present disclosure provides an optical communication emitter 10, including: at least one light emitting unit 2, each light emitting unit 2 including at least two light sources 30, each of the at least two light sources emitting light of a different color, wherein a unit optical communication time is divided into a number of time slots, which number corresponds to the number of the light sources included in each light emitting unit, each time slot corresponds to the light sources that emit light of the same color, the light sources corresponding to different time slots are different, and each of the light sources can only emit light in the corresponding time slot. During the unit optical communication time, the light emitted by the plurality of light sources is superimposed as a composite light.

In a specific example, the optical communication emitter 10 includes a plurality of light emitting units 2 arranged in an array. As shown in FIGS. 2 and 3, the optical communication emitter 10 includes a substrate 1, the plurality of light emitting units 2 arranged in an array on the substrate 1, and a protective film 3 covering the plurality of light emitting units 2. Each of the light emitting units 2 includes a plurality of light sources that emit light of different colors. In the present embodiment, each of the light emitting units 2 includes three light sources, i.e., a red light source 21, a green light source 22, and a blue light source 23. Those skilled in the art may design the number of light sources according to actual requirements, so as to meet the practical applications.

In a specific application, the optical communication emitter 10 further includes a clock controller 40 for controlling the light sources to emit light in corresponding time slots. The clock controller 40 divides the unit optical communication time into a number of time slots according to the number of the light sources, and each of the light sources can only emit light in the corresponding time slot. The durations of the plurality of time slots may be set to be the same or may be set to be different, which may designed by those skilled in the art according to actual requirements. In this embodiment, such three light sources as the red light source, the green light source, and the blue light source may be taken as an example, and the unit display time is evenly divided into three time slots, wherein the first time slot corresponds to the red light source, the second time slot corresponds to the green light source, and the third time slot corresponds to the blue light source. The optical communication emitter 10 controls the three light sources in chronological order, and only one light source emits a light signal in the corresponding time slot. In a case of using optical communication, the switching frequency of the light sources is generally set to be 60 Hz to 120 Hz, which is much higher than the recognition ability of the human eye(s) to the light. The light emitted by the optical communication emitter during the unit optical communication time is superimposed, and presents a composite light with a mixed color effect.

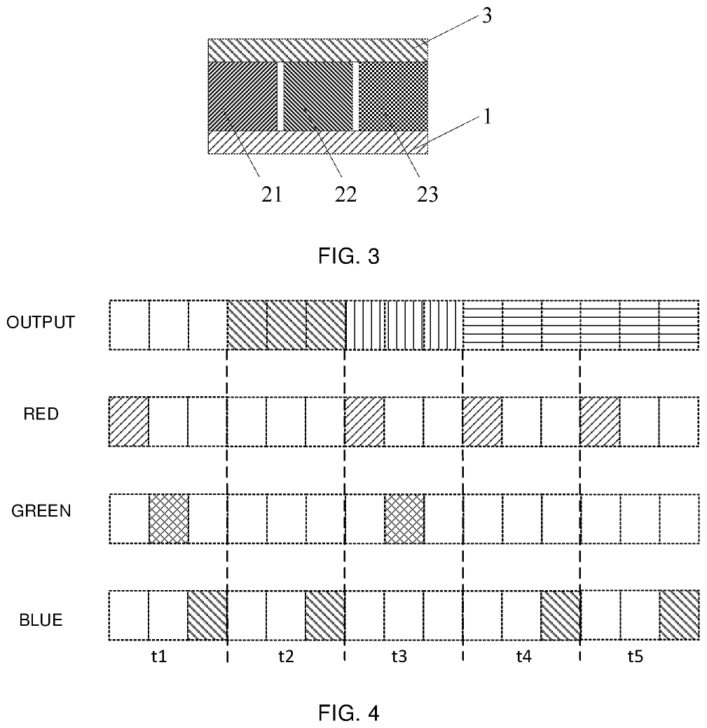

As shown in FIG. 4, at time t1, the three, i.e., red, green and blue, light sources emit light sequentially, and the light emitted by the optical communication emitter presents a white color. Assuming that a photodetector output of an optical communication receiver is 1 when the optical communication receiver receives red light through a red optical filter and is 0 when the red light is not received, then if the three red, green and blue light sources on the optical communication emitter emit light sequentially within t1, and the optical communication receiver receives the light emitted by each light source through the optical filter and the photodetector corresponding to the optical communication emitter, then the photodetector of the optical communication receiver outputs a first electrical signal of a set of data (1, 1, 1) at time t1; similarly, at time t2, no light is emitted from the red and the green light sources, the optical communication emitter presents a blue color, and the optical communication receiver outputs a first electrical signal of a set of data (0, 0, 1); and so on. At time t1 to t5, the optical communication emitter presents a phenomenon of rapid flashing of a plurality of colors, and the optical communication receiver outputs a first electrical signals of a series of data (1, 1, 1), (0, 0, 1), (1, 1, 0), (1, 0, 1), (1,0,1).

In order to further enhance transmission security of the visible light communication, in an embodiment, the optical communication emitter is configured to adjust a brightness of light emitted by at least one of at least two light sources in each light emitting unit. The brightness adjustment is invisible to the naked eye(s), so that the color of the light emitted by the optical communication emitter observed by the naked eye(s) does not change. Further, the light source can be controlled independently and can emitting light separately, and may be any of a Micro-Light-Emitting Diode (Micro-LED), an LED or an Organic Light-Emitting Diode (OLED). In one embodiment, the optical communication emitter further includes a voltage controller 50 for adjusting a voltage applied to the light source, so as to adjust the brightness of the light emitted by the light source.

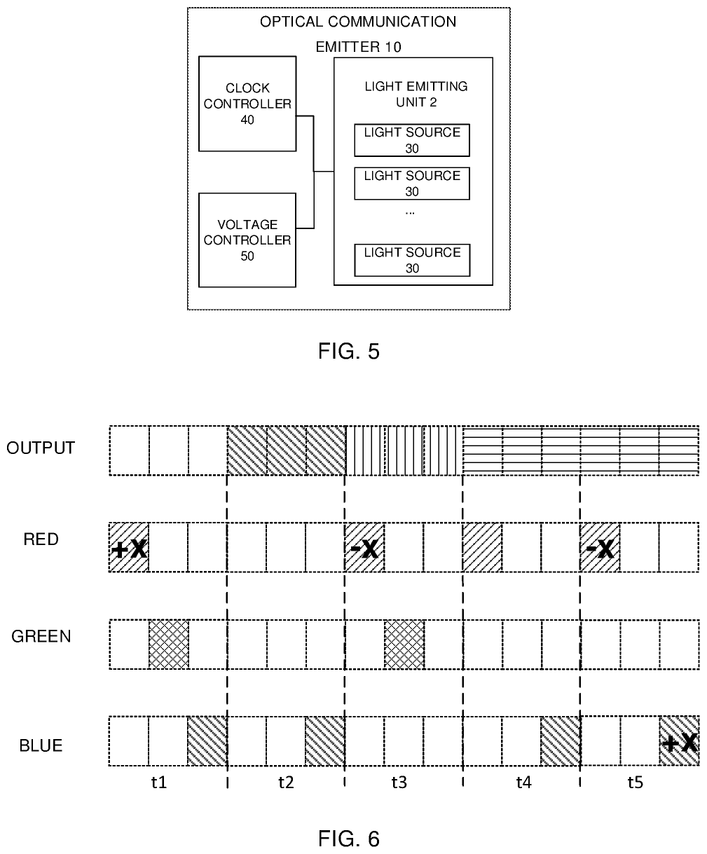

As shown in FIG. 5, the optical communication emitter further includes a voltage controller 50 for respectively controlling voltages applied to the plurality of light sources, so as to adjust the brightness of the light emitted by the light sources without changing the color of the composite light observed by the naked eye(s). In the present embodiment, the voltage applied to the light source is controlled by the voltage controller, and the voltage is finely adjusted to adjust the output current in order to change the brightness of the light emitted by the light source. That is, the brightness of the light emitted by the respective light sources is adjusted without changing the color of the composite light, so as to achieve encryption of the light signal emitted by the light source such that the data received by the corresponding optical communication receiver differs from the original data. As shown in FIG. 6, at time t1, the three red, green and blue light sources of the optical communication emitter emit light sequentially, and the voltage applied to the red light source is controlled to be increased or reduced to change the brightness of the emitted red light. The change of the brightness is not detectable by the naked eye(s). The optical communication emitter still presents a white color at time t1, but the receiving circuit of the corresponding optical communication receiver processes the first electrical signal output from the photodetector, and outputs a second electrical signal, that is, processing the brightness of the received red light. For example, the first electrical signal (1, 1, 1) output by the optical communication receiver without being encrypted changes to the second electrical signal (1+X, 1, 1) output after being encrypted; and so on. At time t1 to t5, the optical communication emitter presents a phenomenon of rapid flashing of a plurality of colors, the color of the optical communication emitter observed by the observer with the naked eye(s) is consistent with that before the encryption, and the series of electrical signals output by the optical communication receiver change from the unencrypted first electrical signal (1, 1, 1), (0, 0, 1), (1, 1, 0), (1, 0, 1), (1,0,1) to the second encrypted second electrical signal (1+X, 1, 1), (0, 0, 1), (1−X, 1, 0), (1, 0, 1), (1−X, 0, 1+X), thereby improving the transmission security of the optical communication. The voltage control for increasing or reducing the voltage of the light source is determined by the characteristics of the specific light source used, which shall be appropriately set by those skilled in the art according to the specific parameters of the light source actually used.

Corresponding to the optical communication emitter provided by the above embodiments, an embodiment of the present disclosure further provides an emitting method using the above optical communication emitter. Since the description of the emitting method provided by the embodiment of the present disclosure is corresponding to that of the optical communication emitter according to the foregoing several embodiments, the foregoing embodiments are also applicable to the emitting method provided in the present embodiment, which will not be described in detail herein.

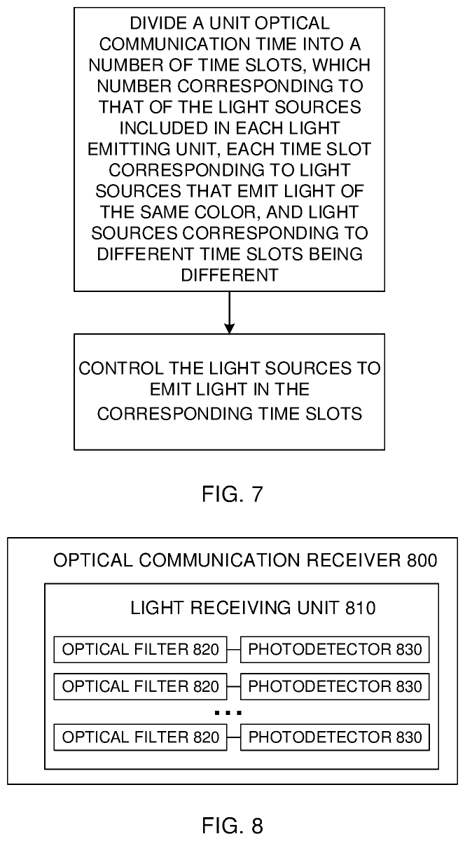

As shown in FIG. 7, an embodiment of the present disclosure provides an emitting method using the above optical communication emitter, including: dividing a unit optical communication time into a number of time slots, which number correspond to the number of the light sources included in each light emitting unit, each time slot corresponding to the light sources that emit light of the same color, and the light sources corresponding to different time slots being different; and controlling each of the light sources to emit light in the corresponding time slot.

In a preferred embodiment, when each of the light sources is controlled to emit light in the corresponding time slot, the emitting method further includes: adjusting a brightness of light emitted by at least one of the at least two light sources in each of the at least one light emitting unit, wherein the brightness adjustment is invisible to the naked eye(s). Further, in order to simplify the transmission control process, the durations of the plurality of time slots may be set to be the same. That is, the clock controller of the optical communication emitter divides the unit optical communication time equally according to the number of the light sources, and the durations of the respective time slots are the same.

Corresponding to the above optical communication emitter, as shown in FIG. 8, the present disclosure also provides an optical communication receiver 800 for use with the above optical communication emitter. The optical communication receiver 800 includes at least one light receiving unit 810, wherein each light receiving unit 810 includes at least two optical filters 820 and photodetectors 830, wherein the at least two optical filters are used to filter out different colors of light emitted by the at least two light sources, respectively. The photodetector detects the light emitted by the corresponding light source that is filtered out by the corresponding optical filter and outputs the first electrical signal.

In one embodiment, the optical communication emitter includes three, i.e., red, green and blue light sources, the light receiving unit of the optical communication receiver includes three, i.e., red, green and blue, optical filters and corresponding photodetectors. Thus, the photodetector corresponding to the red optical filter receives the red light that is filtered out by the red optical filter in the first time slot, the photodetector corresponding to the green optical filter receives the green light that is filtered out by the green optical filter in the second time slot, and the photodetector corresponding to the blue optical filter receives the green light that is filtered out by the blue optical filter in the third time slot. The light receiving unit receives light in the composite light that is emitted by each light source according to the receiving timing sequence corresponding to the emitting timing sequence of the light emitting unit.

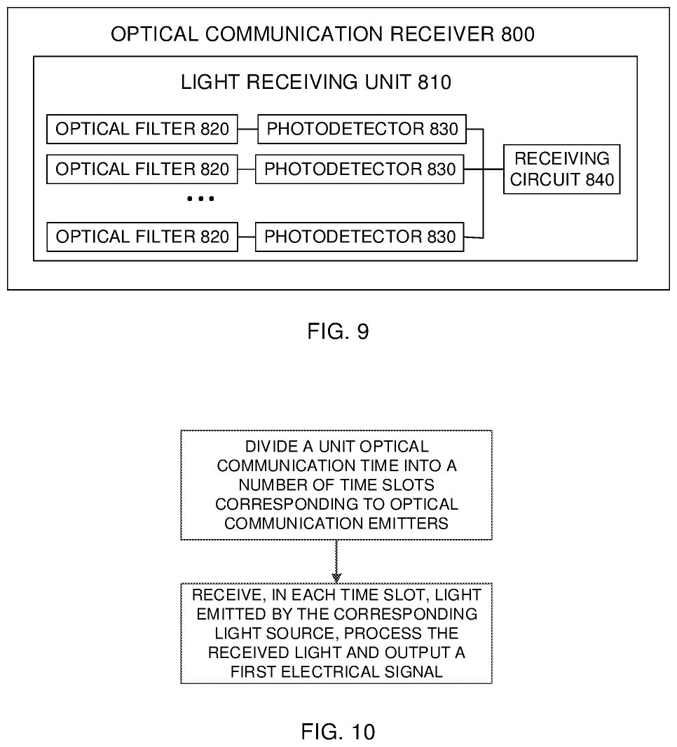

In a preferred embodiment, as shown in FIG. 9, the optical communication receiver 800 further includes a receiving circuit 840 that processes the first electrical signal and outputs a second electrical signal corresponding to the brightness of the received light. That is, an operation that is reverse to the encryption operation performed by the optical communication emitter is completed, wherein in the encryption operation, the voltage applied to the light source is changed by the voltage controller. Therefore, both the encryption and the decryption of the optical communication are implemented by the optical communication emitter and the optical communication receiver, thereby effectively improving the security of the visible light communication.

The receiving circuit of the optical communication receiver may, for example, include an amplifier, an equalizer and a decider for processing the light received by the photodetector.

Corresponding to the optical communication receiver provided by the above embodiments, an embodiment of the present disclosure further provides a receiving method using the above optical communication receiver. Since the description of the receiving method according to the embodiment of the present disclosure is corresponding to that of the optical communication receiver according to the foregoing several embodiments, the foregoing embodiments are also applicable to the receiving method provided in the present embodiment, which will not be described in detail herein.

As shown in FIG. 10, an embodiment of the present disclosure provides a receiving method using the above optical communication receiver, which includes: dividing a unit optical communication time into a number of time slots corresponding to those of an optical communication emitter; receiving light emitted by a light source in a corresponding time slot, processing the received light, and outputting the first electrical signal.

In a preferred embodiment, the receiving method further includes: processing a brightness of the light emitted by the light source, and outputting a second electrical signal.

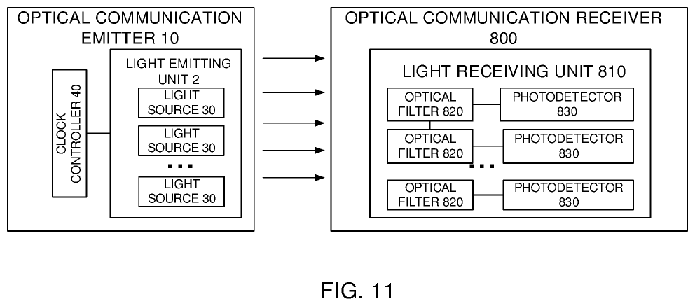

As shown in FIG. 11, an embodiment of the present disclosure provides an optical communication transceiving system, which includes the optical communication emitter and optical communication receiver as described above.

According to an embodiment of the present disclosure, the light emitted by the plurality of light sources of different colors is superimposed to form a composite light in the unit optical communication time, according to the timing sequence generated by the clock controller of the optical communication emitter. Thus, the data may be transmitted while being displayed, which may effectively improve the transmission efficiency of the optical communication.

Corresponding to the above optical communication emitter and optical communication receiver, the present disclosure also provides a key for an optical communication smart door lock. The key includes the above optical communication emitter, which is used with an optical communication smart door lock including the optical communication receiver as described above. For example, the key transmits an unlocking signal to the optical communication smart door lock according to a preset encrypted visible light, and the optical communication smart door lock receives and decrypts the unlocking signal, and compares it with preset data. If the data are matched, the door is unlocked; otherwise, the door is not unlocked.

Meanwhile, the optical communication emitter may also be used for data loading in a field sequential color display, which controls, within the unit display time, each light source to emit light in the corresponding time slot, so as to load the data while the data are being displayed.

It is apparent that the above-described embodiments of the present disclosure are merely illustrative of the present disclosure, but are not intended to limit the embodiments of the present disclosure. For those skilled in the art, different forms of variations or modifications may be made based on the above description, which cannot be listed exhaustively here. It is to be understood that various variations or modifications may be made without departing from the spirit and scope of the present disclosure.

I/We claim:

1. An optical communication emitter, comprising:
at least one light emitting unit, each light emitting unit comprising at least two light sources, each of the at least two light sources emitting light of a different color,
wherein a unit optical communication time is divided into a number of time slots, which number corresponds to the number of the light sources included in each light emitting unit, each time slot corresponds to the light sources that emit light of the same color, the light sources corresponding to different time slots are different, and each of the light sources can only emit light in the corresponding time slot.

2. The optical communication emitter of claim 1, wherein the optical communication emitter is configured to adjust a brightness of light emitted by at least one of the at least two light sources in each of the at least one light emitting unit, and the brightness adjustment is invisible to naked eye(s).

3. The optical communication emitter of claim 1, further comprising:
a clock controller configured to control the light sources to emit light in the corresponding time slots.

4. The optical communication emitter of claim 2, wherein
the light source is any of an Organic Light-Emitting Diode (OLED), a micro-LED or an LED.

5. The optical communication emitter of claim 4, further comprising a voltage controller configured to adjust a voltage applied to the at least one of the at least two light sources, so as to adjust a brightness of the light emitted by the at least one of the at least two light sources.

6. The optical communication emitter of claim 1, wherein the at least one light emitting unit comprises a plurality of light emitting units arranged in an array.

7. The optical communication emitter of claim 1, wherein each of the plurality of time slots has the same or a different duration.

8. An emitting method of an optical communication emitter, the optical communication emitter comprising: at least one light emitting unit, each light emitting unit comprising at least two light sources, each of the at least two light sources emitting light of a different color, the emitting method comprising:
dividing a unit optical communication time into a number of time slots, which number correspond to the number of the light sources included in each light emitting unit, each time slot corresponding to the light sources that emit light of the same color, and the light sources corresponding to different time slots being different; and
controlling each of the light sources to emit light in the corresponding time slot.

9. The emitting method of claim 8, further comprising:
adjusting a brightness of light emitted by at least one of the at least two light sources in each of the at least one light emitting unit, wherein the brightness adjustment is invisible to naked eye(s).

10. An optical communication transceiving system, comprising:
an optical communication emitter, the optical communication emitter comprising at least one light emitting unit, each light emitting unit comprising at least two light sources, each of the at least two light sources emitting light of a different color, wherein a unit optical communication time is divided into a number of time slots, which number correspond to the number of the light sources included in each light emitting unit, each time slot corresponds to the light sources that emits light of the same color, the light sources corresponding to different time slots are different, and each of the light sources can only emit light in the corresponding time slot; and
an optical communication receiver comprising at least one light receiving unit, wherein each light receiving unit comprises at least two optical filters and photodetectors, wherein the at least two optical filters are used for filtering out light of different colors emitted by the at least two light sources respectively, and the photodetector detects light emitted by a corresponding light source, which is filtered out by the corresponding optical filter, and outputs a first electrical signal.

11. The optical communication transceiving system of claim 10, wherein
the optical communication emitter is configured to adjust a brightness of light emitted by at least one of the at least two light sources in each of the at least one light emitting unit, and the brightness adjustment is invisible to naked eye(s); and
the optical communication receiver further comprises a receiving circuit that processes the first electrical signal and outputs a second electrical signal corresponding to a brightness of the received light.

12. The optical communication transceiving system of claim 10, wherein the optical communication emitter further comprises:
a clock controller configured to control the light sources to emit light in the corresponding time slots.

13. The optical communication transceiving system of claim 10, wherein the light source is any of an Organic Light-Emitting Diode (OLED), a micro-LED or an LED.

14. The optical communication transceiving system of claim 12, wherein the optical communication emitter further comprises a voltage controller configured to adjust a voltage applied to the at least one of the at least two light sources, so as to adjust a brightness of the light emitted by the at least one of the at least two light sources.

15. The optical communication transceiving system of claim 10, wherein the at least one light emitting unit comprises a plurality of light emitting units arranged in an array.

16. The optical communication transceiving system of claim 10, wherein each of the plurality of time slots has the same or a different duration.

17. A key for an optical communication smart door lock, wherein the key comprises the optical communication emitter of claim 1.
